(19) United States
(12) Patent Application Publication
(10) Pub. No.: US 2026/0160870 A1
(43) Pub. Date: Jun. 11, 2026

(54) ULTRASONIC SENSOR DEVICE FOR A MOTOR VEHICLE, AND ULTRASONIC SENSOR ASSEMBLY

(71) Applicant: Continental Autonomous Mobility Germany GmbH, Ingolstadt (DE)

(72) Inventor: Martin Haverkamp, Frankfurt am Main (DE)

(73) Assignee: Continental Autonomous Mobility Germany GmbH, Ingolstadt (DE)

(21) Appl. No.: 18/707,574

(22) PCT Filed: Oct. 14, 2022
(86) PCT No.: PCT/DE2022/200236

§ 371 Date: May 4, 2024

(30) Foreign Application Priority Data
Nov. 4, 2021 (DE) 10 2021 212 410.0
Nov. 4, 2021 (DE) 10 2021 212 426.7
Mar. 24, 2022 (DE) 10 2022 202 859.7

(51) Int. Cl. G01S 7/521; G10K 9/22

(52) U.S. Cl. CPC G01S 7/521; G10K 9/22

(57) ABSTRACT

Disclosed is an ultrasonic sensor device for a vehicle. An ultrasonic sensor has a pot-shaped diaphragm including a diaphragm base for emitting/receiving ultrasonic signals and a decoupling ring with a ring portion having a hollow cylinder shape and at least portions of the inner peripheral wall which abut an outer lateral diaphragm surface. The diaphragm is inserted, with the decoupling ring, at least in portions into a recess in a covering part of the vehicle. A preloading element, at least partially extending around the ring portion, is located at the axial end of the ring portion remote from the diaphragm base. The preloading element extends from the axial end in an axial direction towards the diaphragm base and extends radially outwardly. Also disclosed is an ultrasonic sensor assembly for a vehicle having a covering part, and an ultrasonic sensor device inserted into a recess in the covering part.

### CROSS-REFERENCE TO RELATED APPLICATIONS

The present application is a National Stage Application under 35 U.S.C. § 371 of International Patent Application No. PCT/DE 2022/200236 filed on Oct. 14, 2022, and claims priority from German Patent Application No. 10 2021 212 410.0 filed on Nov. 4, 2021, German Patent Application 10 2021 212 426.7 filed Nov. 4, 2021, and German Patent Application 10 2022 202 859.7 filed Mar. 24, 2022, such German patent applications each filed in the German Patent Office, the content of the international and German patent applications are herein incorporated by reference in their entireties.

### TECHNICAL FIELD

The invention relates to an ultrasonic sensor device for a motor vehicle, including an ultrasonic sensor which has a pot-shaped diaphragm having a diaphragm base for emitting and/or receiving ultrasonic signals and having a decoupling ring which includes a ring portion which has the shape of a hollow cylinder and at least portions of the inner peripheral wall of which abut an outer lateral surface of the diaphragm. The diaphragm may be inserted, together with the decoupling ring, at least in portions into a recess in a covering part, in particular in a bumper, of the motor vehicle. The invention additionally relates to an ultrasonic sensor assembly for a motor vehicle having a covering part, in particular a bumper, and an ultrasonic sensor device of this kind, wherein the ultrasonic sensor device is inserted into a recess in the covering part.

### BACKGROUND

Today's motor vehicles usually have a plurality of ultrasonic sensor devices which are assigned to driver assistance apparatuses such as, for example, parking and/or braking assistance systems, and provide information about the surroundings of the motor vehicle, in particular about obstacles or objects in the surroundings and their distances from the motor vehicle. The ultrasonic sensor devices are located in a distributed manner on the motor vehicle, at least in the front and rear region of the motor vehicle, and are commonly installed on covering parts, in particular on bumpers.

An ultrasonic sensor device of this kind is regularly located in a corresponding opening or recess in the covering part of the motor vehicle in such a way that a front-end or front-side diaphragm base of a pot-shaped diaphragm of an ultrasonic sensor of the ultrasonic sensor device terminates substantially flush with the outer surface of the covering part, wherein ultrasonic waves can be emitted and received via the diaphragm base during operation. The ultrasonic sensor or the diaphragm of the ultrasonic sensor is usually decoupled by a decoupling ring. In this way, it is in particular possible to prevent structure-borne noise from being transmitted from the ultrasonic sensor to the covering part, which would otherwise cause interference.

An ultrasonic sensor device and an ultrasonic sensor assembly of the type mentioned at the outset are known, for example, from DE 20 2014 011 304 U1 or EP 2 812 723 B1, and reference is made in full to the disclosure of these two documents with regard to the fundamental importance. The decoupling ring has, at an axial end of the ring portion of the decoupling ring, an edge which extends perpendicularly to the outer peripheral wall of the ring portion and extends outwardly in a radial direction, and completely extends around the ring portion, between the ultrasonic sensor and a bumper. From this complete edge, substantially coaxially circumferential elastic ribs extend in an axial direction perpendicularly to the edge, wherein a depression or interruption is located in each case between the ribs in the circumferential direction. The ribs act like compression springs for preloading in an axial direction of the decoupling ring between the ultrasonic sensor and the bumper.

Thanks to such a configuration, the preloading of the decoupling ring between the ultrasonic sensor and the bumper varies considerably, in a detrimental manner, in an axial direction, even if the material thickness of the bumper is varied from 2 to 4 mm. By varying the material thickness of the bumper from 2 to 4 mm, in the case of a total height of the decoupling ring of 5 mm, only a small material thickness for the edge and the ribs of approx. 0.7 mm can be realized, since these have to be compressed to a total height of 1 mm in extreme cases. On the one hand, the ribs generate a significantly increasing preload force as the bumper thickness increases. On the other hand, as the bumper thickness increases, so does the risk of buckling of the ribs, that is to say the risk of the ribs folding over, and this results in a significantly decreasing preload force.

### SUMMARY

The object of the present disclosure is to indicate an improved configuration for an ultrasonic sensor device as well as for a corresponding ultrasonic sensor assembly.

The above object is addressed by the entire teaching of claim 1 and of claim 15. Expedient embodiments and further developments of the invention are set out in the subclaims and the following description.

Accordingly, an ultrasonic sensor device for a motor vehicle comprises an ultrasonic sensor which has a pot-shaped diaphragm having a diaphragm base for emitting and/or receiving ultrasonic signals as well as a decoupling ring which has a ring portion which has the shape of a hollow cylinder and at least portions of the inner peripheral wall of which abut an outer lateral surface of the diaphragm. The diaphragm may be inserted, together with the decoupling ring, at least in portions into a recess in a covering part, in particular in a bumper, of the motor vehicle.

According to the present disclosure, a preloading element which at least partially extends around the ring portion is located at the axial end of the ring portion, which axial end is remote from the diaphragm base, which preloading element extends from the axial end in an axial direction towards the diaphragm base and extends outwardly in a radial direction.

As a result of a connection of this kind of the preloading element to the ring portion and the configuration of the preloading element, a free space is initially provided in a radial direction in the region of the axial end of the ring portion remote from the diaphragm base, into which free space the preloading element may then at least be partially pressed due to its deformation when the ultrasonic sensor device is in the assembled state. As a result, the preload force may be designed to be more uniform in the range of a minimum to maximum bumper thickness, wherein the preload force does not increase significantly, in particular when the bumper thickness increases, and the material thickness of the preloading element may in addition be made sufficiently large.

Consequently, the overall advantage of the configuration according to the present disclosure is that an improved configuration is thereby provided for an ultrasonic sensor device.

The preloading element acts like a bending spring in an axial direction and, when the diaphragm is in the assembled state, together with the decoupling ring, in the recess in the covering part, preloads the decoupling ring axially between the ultrasonic sensor and the covering part.

Advantageously, the decoupling ring may be completely configured from an elastic material, such as a polymer, and more particularly, a silicon.

In an advantageous embodiment, the preloading element extends directly from the axial end in an axial direction towards the diaphragm base and extends outwardly in a radial direction. That is to say that the preloading element is directly connected to the axial end of the ring portion. In particular, the decoupling ring consequently does not have an edge which extends perpendicularly to the outer peripheral wall of the ring portion and extends outwardly in a radial direction, and which completely extends around the ring portion, at the axial end of the ring portion remote from the diaphragm base.

In a further advantageous embodiment, the preloading element is designed to be curved radially inwardly in the circumferential direction. Consequently, the preloading element has a curved part directed radially inwardly towards the ring portion. The preloading element may be designed to be curved radially inwardly along its entire extent in the circumferential direction.

In a further advantageous embodiment, the preloading element has a substantially constant material thickness over its entire cross-sectional profile.

In an advantageous embodiment, a force application element for applying a preload force in an axial direction to the preloading element is located on a surface of the preloading element facing the ring portion. That is to say that the preloading element has a force application element on its surface facing the ring portion, via which the preload force is applied in an axial direction to the preloading element when the diaphragm is in the assembled state, together with the decoupling ring, in the recess in the covering part, wherein the force application element may extend in an axial direction beyond the surface of the preloading element. In the circumferential direction, the force application element only extends in particular over a partial region of the preloading element, wherein the force application element may be located centrally on the surface of the preloading element facing the ring portion in the circumferential direction. The force application element advantageously has a cross-sectional profile which has the shape of a wedge.

The decoupling ring advantageously has at least two preloading elements distributed over the circumference of the ring portion, wherein the preloading elements may be distributed uniformly over the circumference of the ring portion, and wherein the two preloading elements may be located at a distance from one another in the circumferential direction. The two preloading elements advantageously have the same extent in the circumferential direction and both preloading elements are in particular configured identically to one another. In particular, the preloading elements have, in addition, a respective force application element, wherein the force application elements may be configured identically to one another.

In a further advantageous embodiment, however, the decoupling ring has at least three preloading elements distributed over the circumference of the ring portion, wherein the preloading elements may be distributed uniformly over the circumference of the ring portion, and wherein the preloading elements are each located at a distance from one another in the circumferential direction. All of the preloading elements advantageously have the same extent in the circumferential direction and all of the preloading elements are in particular configured identically to one another. In particular, all of the preloading elements have a respective force application element, wherein the force application elements may be configured identically to one another.

In a further advantageous embodiment, the decoupling ring has, at the axial end of the ring portion remote from the diaphragm base, at least one edge section extending perpendicularly to the outer peripheral wall of the ring portion and extending outwardly in a radial direction, which edge section, when the diaphragm is in the assembled state, together with the decoupling ring, in the recess in the covering part, forms a stop element which interacts with a stop surface configured on the covering part.

In a further advantageous embodiment, the edge section is located directly adjacent to the preloading element in the circumferential direction.

In a further advantageous embodiment, the decoupling ring includes at least three preloading elements distributed over the circumference of the ring portion, wherein the preloading elements may be distributed uniformly over the circumference of the ring portion, as well as at the axial end of the ring portion remote from the diaphragm base, at least three edge sections which each extends perpendicularly to the outer peripheral wall of the ring portion and extends outwardly in a radial direction, which edge sections, when the diaphragm is in the assembled state, together with the decoupling ring, in the recess in the covering part, forms a respective stop element which interacts with a stop surface configured on the covering part. A respective edge section is located in each case between two neighboring preloading elements in the circumferential direction, wherein a respective edge section is located directly adjacent to its two neighboring preloading elements.

In a further advantageous embodiment, the decoupling ring has a single preloading element which completely extends around the ring portion. In particular, the decoupling ring does not have an edge section in this case.

In a further advantageous embodiment, the decoupling ring has at least one curved part on the outer peripheral wall of the ring portion, which curved part surrounds the ring portion on the circumference and which extends in a radial direction from the ring portion, perpendicularly to the outer peripheral wall, towards a free end. The curved part may surround the ring portion completely on the circumference. A cross-section of the curved part advantageously tapers from the ring portion towards the free end. The curved part makes possible an elastically damping effect of the decoupling ring, additionally, in a radial direction.

In a further advantageous embodiment, when the diaphragm is in the assembled state, together with the decoupling ring, in the recess in the covering part, the free end of the curved part abuts the covering part. As a result, the decoupling ring may additionally have an elastically damping effect in a radial direction.

In a further advantageous embodiment, the decoupling ring has two curved parts on the outer peripheral wall of the ring portion, wherein the two curved parts are located at a distance from one another in an axial direction. The curved parts each may surround the ring portion completely on the circumference. A cross-section of the curved parts advantageously tapers in each case from the ring portion towards the free end. The two curved parts may extend the same distance in a radial direction or may have a different extent in a radial direction. The decoupling ring may also have more than two curved parts of this kind. When the diaphragm is in the assembled state, together with the decoupling ring, in the recess in the covering part, the respective free end of each curved part advantageously abuts the covering part.

In a further advantageous embodiment, the decoupling ring is configured in one piece.

The ultrasonic sensor device advantageously has a sensor holder for fastening the ultrasonic sensor device to the covering part, wherein the ultrasonic sensor and/or the decoupling ring is/are located at least in sections in a receiving section of the sensor holder.

The present disclosure additionally includes an ultrasonic sensor assembly for a motor vehicle having a covering part, in particular a bumper, and an ultrasonic sensor device according to the present disclosure, wherein the ultrasonic sensor device, in particular the diaphragm, is inserted, together with the decoupling ring, into a recess in the covering part.

The described advantages and example embodiments for the ultrasonic sensor device according to the present disclosure also apply accordingly to the ultrasonic sensor assembly according to the present disclosure.

The ultrasonic sensor device is advantageously inserted into the recess in the covering part such that the diaphragm base of the diaphragm and an outer side in the covering part substantially form one plane.

### BRIEF DESCRIPTION OF THE DRAWINGS

Example embodiments of the present disclosure are explained in more detail below with reference to a drawing, wherein:

FIG. 1 shows a top view of a decoupling ring,

FIG. 2 shows a perspective representation of the decoupling ring according to FIG. 1 as well as a position of the sectional planes of FIGS. 3a and 3b,

FIG. 3a shows a cross-section through the preloading elements of the decoupling ring according to FIG. 2,

FIG. 3b shows a cross-section through the edge sections of the decoupling ring according to FIG. 2,

FIG. 4a shows an ultrasonic sensor assembly having a bumper as well as an ultrasonic sensor device having a decoupling ring according to FIGS. 1 to 3b in an assembled state in a cross-section through the preloading elements,

FIG. 4b shows the ultrasonic sensor assembly according to FIG. 4a in a cross-section through the edge sections of the decoupling ring,

FIG. 5 shows an alternative embodiment of a decoupling ring in a cross-section through the preloading elements,

FIG. 6 shows a further alternative embodiment of a decoupling ring in a perspective representation,

FIG. 7 shows a cross-section through the decoupling ring according to FIG. 6,

FIG. 8 shows a cross-section of an ultrasonic sensor assembly having a bumper as well as an ultrasonic sensor device having a decoupling ring according to FIGS. 6 to 7 in an assembled state,

FIG. 9 shows a further alternative embodiment of a decoupling ring in a top view, and

FIG. 10 shows a perspective representation of the decoupling ring according to FIG. 9.

### DETAILED DESCRIPTION

Corresponding parts are always provided with the same reference numerals in all of the figures.

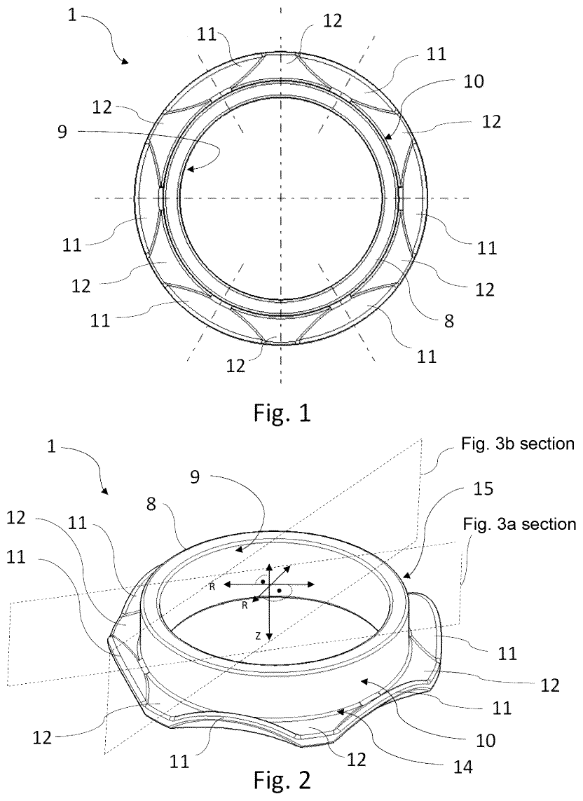

An example embodiment of a decoupling ring 1 of an ultrasonic sensor device 2 is depicted in different views in FIGS. 1 to 3b. In addition to the decoupling ring 1, the ultrasonic sensor device 2 includes an ultrasonic sensor 3 which has a pot-shaped diaphragm 4 having a diaphragm base 5 for emitting and/or receiving ultrasonic signals, and is configured for arrangement at least in portions in a recess 6 in a bumper 7 of a motor vehicle. The decoupling ring 1 is configured in one piece from an elastic material.

The decoupling ring 1 is depicted in a top view in FIG. 1. The decoupling ring 1 comprises a ring portion 8 which has the shape of a hollow cylinder having an inner peripheral wall 9 and an outer peripheral wall 10. The decoupling ring 1 additionally has six preloading elements 11 uniformly distributed over the circumference of the ring portion 8, which each partially extends around the ring portion 8. The preloading elements 11 are each designed to be curved radially inwardly in the circumferential direction along their entire extent towards the ring portion 8. The preloading elements 11 each has the same extent in the circumferential direction and is configured identically to one another. When the ultrasonic sensor device 2 is in an assembled state, each of these preloading elements 11 acts like a bending spring in an axial direction Z and preloads the decoupling ring 1 axially between the ultrasonic sensor 3 and the bumper 7.

In addition, the decoupling ring 1 has a respective edge section 12 in each case between two neighboring preloading elements 11 in the circumferential direction and directly adjacent to the two neighboring preloading elements 11, thus a total of six edge sections 12 uniformly distributed over the circumference of the ring portion 8. The edge sections 12 each extends perpendicularly to the outer peripheral wall 10 of the ring portion 8 and extends outwardly in a radial direction R, and each partially extends around the ring portion 8. The edge sections 12 each has the same extent in the circumferential direction and is configured identically to one another. When the ultrasonic sensor device 2 is in the assembled state, the edge sections 12 form stop elements which each interacts with a respective stop surface 13 configured on the bumper 7.

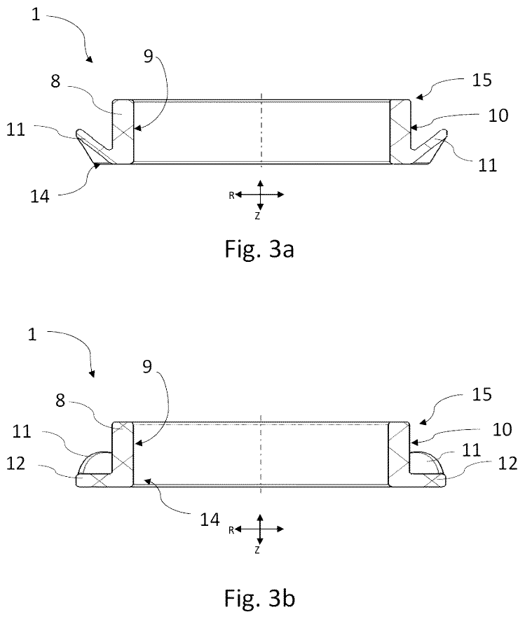

FIG. 2 shows a perspective representation of the decoupling ring 1 according to FIG. 1 as well as a position of the sectional planes of FIGS. 3a and 3b, wherein a cross-section through the preloading elements 11 of the decoupling ring 1 is depicted in FIG. 3a, and wherein a cross-section through the edge sections 12 of the decoupling ring 1 is depicted in FIG. 3b.

It is clear from FIGS. 2 and 3a that the preloading elements 11 are each located directly at an axial end 14 of the ring portion 8, that is to say they extend directly from this axial end 14. When the ultrasonic sensor device 2 is in the assembled state, this axial end 14 constitutes the axial end 14 of the ring portion 8 remote from the diaphragm base 5 of the diaphragm 4 of the ultrasonic sensor 3. The preloading elements 11 each extends from this axial end 14 in an axial direction Z towards the opposite, further axial end 15 of the ring portion 8 and, consequently, towards the diaphragm base 5 of the diaphragm 4 of the ultrasonic sensor 3 and extends outwardly in a radial direction R. In addition, the preloading elements 11 each has a constant material thickness over its total cross-sectional profile. As a result of a configuration of this kind, a free space is initially provided in a radial direction R in the region of the axial end 14 of the ring portion 8 remote from the diaphragm base 5, into which free space the preloading elements 11 may then at least be partially pressed due to their deformation when the ultrasonic sensor device 2 is in the assembled state. As a result, a preload force may be designed to be more uniform in the range of a minimum to maximum bumper thickness, wherein the preload force does not increase significantly, in particular when the bumper thickness increases, and the material thickness of the preloading elements 11 and edge sections 12 may in addition be made sufficiently large.

Furthermore, it is clear from FIGS. 2 and 3b that the edge sections 12 are also each located directly at the axial end 14 of the ring portion 8 and extends from this axial end 14 perpendicularly to the outer peripheral wall 10 of the ring portion 8 and extends outwardly in a radial direction R.

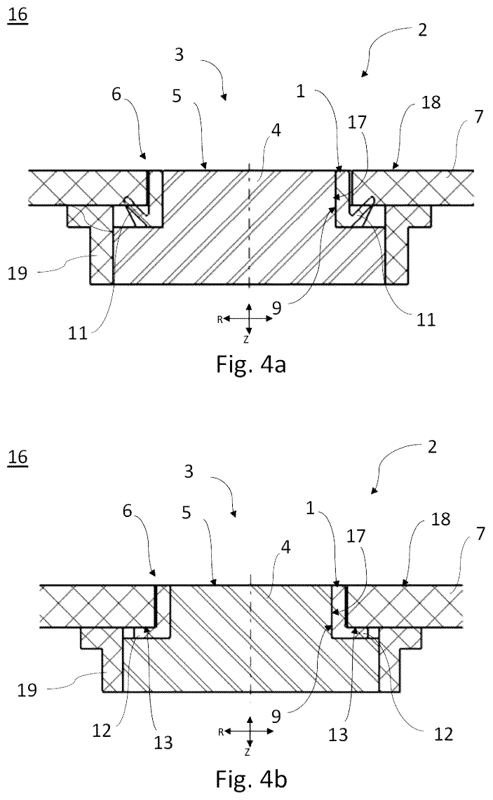

FIG. 4a shows an ultrasonic sensor assembly 16 for a motor vehicle having a bumper 7 as well as an ultrasonic sensor device 2 having a decoupling ring 1 according to FIGS. 1 to 3b in an assembled state in a cross-section through the preloading elements 11. The ultrasonic sensor device 2 includes an ultrasonic sensor 3 which has a pot-shaped diaphragm 4 having a diaphragm base 5 for emitting and/or receiving ultrasonic signals as well as the decoupling ring 1.

The decoupling ring 1, with the inner peripheral wall 9 of its ring portion 8, abuts an outer lateral surface 17 of the diaphragm 4. The ultrasonic sensor device 2 or the diaphragm 4, together with the decoupling ring 1, is inserted into a recess 6 of the bumper 7 such that the diaphragm base 5 of the diaphragm 4 and an outer side 18 of the bumper 7 form one plane. The ultrasonic sensor device 2 additionally has a sensor holder 19 for fastening the ultrasonic sensor device 2 to the bumper 7, wherein the ultrasonic sensor 3 and the decoupling ring 1 are located at least in sections in a receiving section of the sensor holder 19.

In the representation of FIG. 4a, the ends or tips of the preloading elements 11 erroneously appear to protrude into the bumper 7 (since the drawing program was not able to depict a bending off of the ends or tips of the preloading elements 11). However, in reality, the preloading elements 11 are of course accordingly bent by this amount. That is to say that the preloading elements 11 act like a bending spring in an axial direction Z and preload the decoupling ring 1 axially between the ultrasonic sensor 3 and the bumper 7.

The ultrasonic sensor assembly 16 according to FIG. 4a is shown in FIG. 4b in a cross-section through the edge sections 12 of the decoupling ring 1. It is again obvious from FIG. 4b that the edge sections 12 form stop elements which each interacts with a respective stop surface 13 configured on the bumper 7.

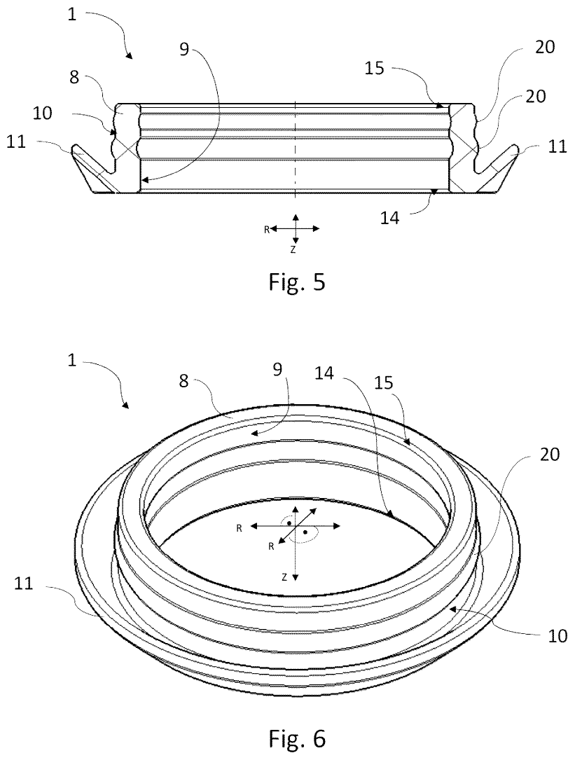

FIG. 5 shows an alternative embodiment of a decoupling ring 1 in a cross-section through the preloading elements 11. The decoupling ring 1 substantially corresponds to the decoupling ring 1 shown in FIGS. 1 to 4b, wherein here the decoupling ring 1 has two curved parts 20 on the outer peripheral wall 10 of the ring portion 8, which each extends in a radial direction R from the ring portion 8 perpendicularly to the outer peripheral wall 10 towards a free end. The two curved parts 20 are located at a distance from one another in an axial direction Z and each surrounds the ring portion 8 completely on the circumference. In addition, the two curved parts 20 extend the same distance in a radial direction R. When the ultrasonic sensor device 2 is in the assembled state, the respective free end of each curved part 20 abuts the bumper 7 such that the decoupling ring 1 may additionally have an elastic damping effect in a radial direction R.

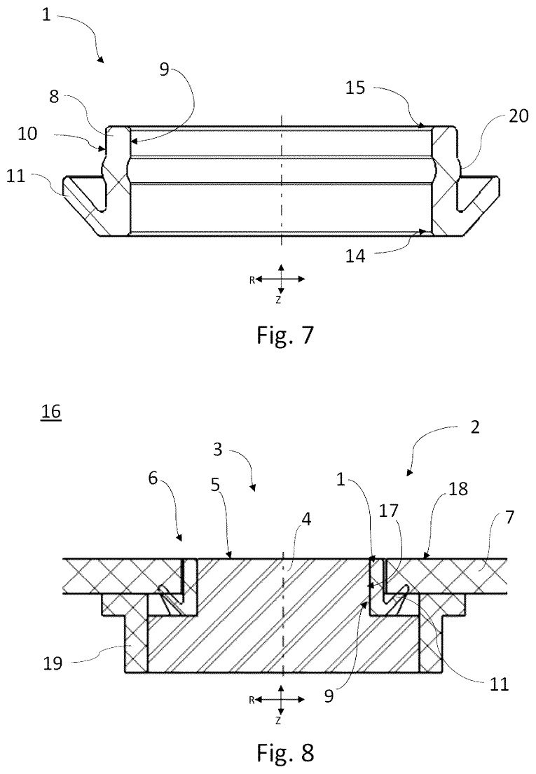

A further alternative embodiment of a decoupling ring 1 of an ultrasonic sensor device 2 is depicted in different views in FIGS. 6 to 7. The decoupling ring 1 is shown in a perspective representation in FIG. 6. The decoupling ring 1 is depicted in a cross-section in FIG. 7.

The decoupling ring 1 substantially corresponds to the decoupling ring 1 shown in FIGS. 1 to 4b, wherein here the decoupling ring 1 only has a single preloading element 11 which completely extends around the ring portion 8. As a result, the decoupling ring 1 does not have an edge section 12.

The preloading element 11 is, in turn, directly located at an axial end 14 of the ring portion 8, that is to say extends directly from this axial end 14. When the ultrasonic sensor device 2 is in the assembled state, this axial end 14 constitutes the axial end 14 of the ring portion 8 remote from the diaphragm base 5 of the diaphragm 4 of the ultrasonic sensor 3. The preloading element 11 extends, in turn, from this axial end 14 in an axial direction Z to the opposite, further axial end 15 of the ring portion 8 and, consequently, towards the diaphragm base 5 of the diaphragm 4 of the ultrasonic sensor 3 and extends outwardly in a radial direction R. Also, as a result of a configuration of this kind, a free space is initially provided in a radial direction R in the region of the axial end 14 of the ring portion 8 remote from the diaphragm base 5, into which free space the preloading element 11 may then at least be partially pressed due to its deformation when the ultrasonic sensor device 2 is in the assembled state. As a result, a preload force may be designed to be more uniform in the range of a minimum to maximum bumper thickness, wherein the preload force does not increase significantly, in particular when the bumper thickness increases, and the material thickness of the preloading element 11 may in addition be made sufficiently large.

Furthermore, a single curved part 20 is configured on the outer peripheral wall 10 of the ring portion 8, which extends in a radial direction R from the ring portion 8 perpendicularly to the outer peripheral wall 10 towards a free end and completely surrounds the ring portion 8 on the circumference. When the ultrasonic sensor device 2 is in the assembled state, the free end of the curved part 20 abuts the bumper 7 such that the decoupling ring 1 may additionally have an elastically damping effect in a radial direction R.

FIG. 8 shows a cross-section of an ultrasonic sensor assembly 16 for a motor vehicle having a bumper 7 as well as an ultrasonic sensor device 2 having a decoupling ring 1 according to FIGS. 6 to 7 in an assembled state, wherein here the curved part 20 on the outer peripheral wall 10 of the ring portion 8 is not depicted.

The ultrasonic sensor device 2 includes an ultrasonic sensor 3 which has a pot-shaped diaphragm 4 having a diaphragm base 5 for emitting and/or receiving ultrasonic signals as well as the decoupling ring 1. The decoupling ring 1 with the inner peripheral wall 9 of its ring portion 8 abuts an outer lateral surface 17 of the diaphragm 4. The ultrasonic sensor device 2 or the diaphragm 4 is inserted, together with the decoupling ring 1, into a recess 6 of the bumper 7 such that the diaphragm base 5 of the diaphragm 4 and an outer side 18 of the bumper 7 form one plane. The ultrasonic sensor device 2 additionally has a sensor holder 19 for fastening the ultrasonic sensor device 2 to the bumper 7, wherein the ultrasonic sensor 3 and the decoupling ring 1 are located at least in sections in a receiving section of the sensor holder 19.

In the representation of FIG. 8, the end or tip of the preloading element 11 erroneously appears to protrude into the bumper 7 (since the drawing program was not able to depict a bending off of the end or tip of the preloading element 11). However, in reality, the preloading element 11 is of course accordingly bent by this amount. That is to say that the preloading element 11 acts like a bending spring on all sides in an axial direction Z and preloads the decoupling ring 1 axially between the ultrasonic sensor 3 and the bumper 7.

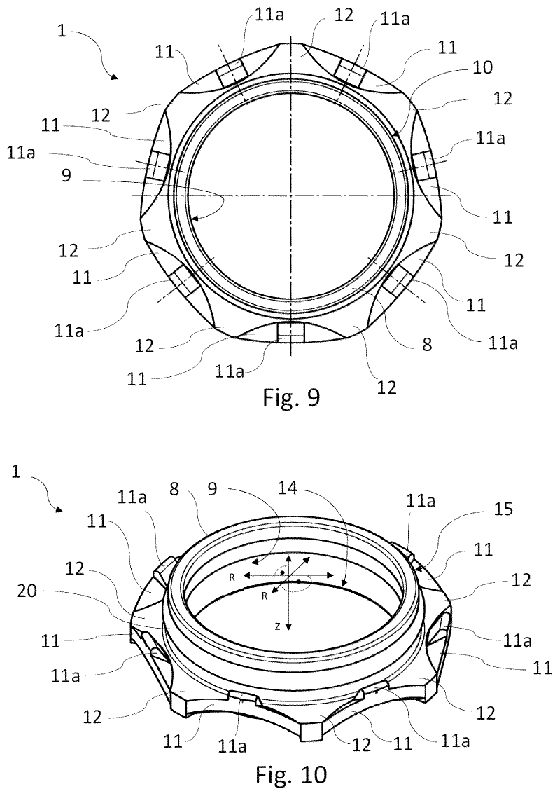

A further alternative embodiment of a decoupling ring 1 of an ultrasonic sensor device 2 is depicted in different views in FIGS. 9 to 10. A top view of the decoupling ring 1 is shown in FIG. 9. A perspective representation of the decoupling ring 1 is depicted in FIG. 10.

The decoupling ring 1 substantially corresponds to the decoupling ring 1 shown in FIGS. 1 to 4b, wherein here the decoupling ring 1 has seven preloading elements 11 uniformly distributed over the circumference of the ring portion 8, which each partially extend around the ring portion 8. The preloading elements 11 are, in turn, each designed to be curved radially inwardly in the circumferential direction along its entire extent towards the ring portion 8. The preloading elements 11 each has the same extent in the circumferential direction and is configured identically to one another. When the ultrasonic sensor device 2 is in the assembled state, each of these preloading elements 11 acts like a bending spring in an axial direction Z and preloads the decoupling ring 1 axially between the ultrasonic sensor 3 and the bumper 7.

Here, the preloading elements 11 each has a force application element 11a for applying the preload force in an axial direction Z to the preloading element 11 on its surface facing the ring portion 8. The respective force application element 11a extends in an axial direction Z in each case beyond the surface of the corresponding preloading element 11. In the circumferential direction, the respective force application element 11a only extends over a partial region of the corresponding preloading element 11, wherein the respective force application element 11a is located centrally on the surface of the corresponding preloading element 11 facing the ring portion 8 in the circumferential direction. The force application element 11a itself has a cross-sectional profile which has the shape of a wedge. A particularly advantageous application of the preload force to the respective preloading element 11 is brought about by means of force application elements 11a of this kind located on the preloading elements 11.

The decoupling ring 1 also has a respective edge section 12 in the circumferential direction in each case between two neighboring preloading elements 11 and directly adjacent to the two neighboring preloading elements 11, thus a total of seven edge sections 12 distributed uniformly over the circumference of the ring portion 8. The edge sections 12 each extends perpendicularly to the outer peripheral wall 10 of the ring portion 8 and extends outwardly in a radial direction R and each extends partially around the ring portion 8. The edge sections 12 each has the same extent in the circumferential direction and is configured identically to one another. When the ultrasonic sensor device 2 is in the assembled state, the edge sections 12 form stop elements which each interacts with a respective stop surface 13 configured on the bumper 7.

Furthermore, a curved part 20 is configured on the outer peripheral wall 10 of the ring portion 8, which curved part extends in a radial direction R from the ring portion 8 perpendicularly to the outer peripheral wall 10 towards a free end and completely surrounds the ring portion 8 on the circumference. When the ultrasonic sensor device 2 is in the assembled state, the free end of the curved part 20 abuts the bumper 7 such that the decoupling ring 1 may additionally have an elastic damping effect in a radial direction R.

### LIST OF REFERENCE NUMERALS

1 Decoupling ring
2 Ultrasonic sensor device
3 Ultrasonic sensor
4 Diaphragm
5 Diaphragm base
6 Recess
7 Bumper
8 Ring portion
9 Inner peripheral wall
10 Outer peripheral wall
11 Preloading element
11a Force application element
12 Edge section
13 Stop surface
14 Axial end
15 Further axial end
16 Ultrasonic sensor assembly
17 Lateral surface
18 Outer side
19 Sensor holder
20 Curved part
R Radial direction
Z Axial direction

1. An ultrasonic sensor device for a motor vehicle, comprising an ultrasonic sensor which has a pot-shaped diaphragm having a diaphragm base for at least one of emitting and/or receiving ultrasonic signals and having a decoupling ring which comprises a ring portion that has a shape of a hollow cylinder and at least portions of the inner peripheral wall which abut an outer lateral surface of the diaphragm, wherein the diaphragm is inserted, together with the decoupling ring, at least in portions into a recess in a covering part of the motor vehicle, wherein a preloading element which at least partially extends around the ring portion is located at an axial end of the ring portion, which axial end is remote from the diaphragm base, which preloading element extends from the axial end in an axial direction towards the diaphragm base and extends outwards in a radial direction.

2. The ultrasonic sensor device according to claim 1, wherein the preloading element extends directly from the axial end in an axial direction towards the diaphragm base and extends outwards in the radial direction.

3. The ultrasonic sensor device according to claim 1, wherein the preloading element is curved radially inwardly in a circumferential direction.

4. The ultrasonic sensor device according to claim 1, wherein the preloading element has a constant material thickness over an entire cross-sectional profile thereof.

5. The ultrasonic sensor device according to claim 1, wherein a force application element for applying a preload force in an axial direction to the preloading element is located on a surface of the preloading element facing the ring portion.

6. The ultrasonic sensor device according to claim 1, wherein the decoupling ring has at least three preloading elements distributed over a circumference of the ring portion, wherein the preloading elements are distributed uniformly over the circumference of the ring portion.

7. The ultrasonic sensor device according to claim 1, wherein the decoupling ring has, at the axial end of the ring portion remote from the diaphragm base, at least one edge section extending perpendicularly to an outer peripheral wall of the ring portion and extending outwards in the radial direction, which edge section, when the diaphragm is in an assembled state together with the decoupling ring, in the recess in the covering part, forms a stop element which interacts with a stop surface configured on the covering part.

8. The ultrasonic sensor device according to claim 7, wherein the edge section is located directly adjacent to the preloading element in the a circumferential direction.

9. The ultrasonic sensor device according to claim 8, wherein a respective edge section is located in each case between two neighboring preloading elements in the circumferential direction.

10. The ultrasonic sensor device according claim 1, wherein the decoupling ring has a single preloading element which completely extends around the ring portion.

11. The ultrasonic sensor device according to claim 1, wherein the decoupling ring has at least one curved part on an outer peripheral wall of the ring portion, which curved part surrounds the ring portion on a circumference and which extends in the radial direction from the ring portion towards a free end.

12. The ultrasonic sensor device according to claim 11, wherein when the diaphragm is in an assembled state together with the decoupling ring in the recess in the covering part, the free end of the at least one curved part abuts the covering part.

13. The ultrasonic sensor device according to claim 11, wherein the decoupling ring has two curved parts on the outer peripheral wall of the ring portion, wherein the two curved parts are located at a distance from one another in the axial direction.

14. The ultrasonic sensor device according to claim 1, wherein the decoupling ring is configured in one piece.

15. An ultrasonic sensor assembly for a motor vehicle having a covering part and an ultrasonic sensor device according to claim 1, wherein the ultrasonic sensor device is inserted into the recess in the covering part.

16. The ultrasonic sensor assembly according to claim 15, wherein the covering part is a bumper of the motor vehicle.

17. The ultrasonic sensor device of claim 1, wherein the covering part comprises a bumper of the motor vehicle.
